(19) United States
(12) Patent Application Publication
(10) Pub. No.: US 2009/0258544 A1
(43) Pub. Date: Oct. 15, 2009

(54) ELECTRICAL CONNECTOR

(75) Inventor: Brent David Allwood, Buttaba (AU)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/370,301

(22) Filed: Feb. 12, 2009

(30) Foreign Application Priority Data
Apr. 10, 2008 (AU) 2008901746

(51) Int. Cl. H01R 24/04

(52) U.S. Cl. 439/668

(57) ABSTRACT

An electrical connector for electrically coupling a plurality of electric contacts of a plug to electrically conductive conductors of an electric data cable, the connector having a first part including a socket shaped to at least partially receive the plug; a second part having a plurality of insulation displacement contact slots; a plurality of electrically conductive contacts extending between the socket and respective ones of said slots; and a bayonet connection for securing the connector at a connection site.

This application is claims benefit of Serial No. 2008901746, filed 10 Apr. 2008 in Australia and which application is incorporated herein by reference. To the extent appropriate, a claim of priority is made to the above disclosed application.

### FIELD OF THE INVENTION

The present invention relates generally to an electrical connector, particularly, but not exclusively, for use in high speed networks.

### BACKGROUND OF INVENTION

Jacks have previously been used in electrical communications networks to electrically connect the insulated conductors of an electrical communications data cable with the insulated conductors of the communications network. Jacks typically include a socket that is shaped to accept a plug coupled to a terminal end of the data cable; and a plurality of insulation displacement contacts for effecting electrical connection to the conductors of the network.

Jacks typically include a mechanism whereby they are snapped into, screwed in, or friction fitted into, a socket of a mounting frame. Jacks that are coupled to mounting frames by way of a “snap in” connection tend to have low tolerance to lateral movement of the jack. Such movement can occur when a data cable is trodden on, or bumped when the plug is removed from the jack. In an office environment, for example, it is foreseeable that jacks will be subject to all manner of rough treatment. As such, they may need to be replaced from time to time. Removing a jack that has been “snapped in” may be difficult if the mechanism by which the jack is snapped in is the section which has failed. Screw in mechanisms for securing jacks to mounting frames can give rise to over-tightening, whereby an operator tightens a screw until the surrounding material is fractured. In addition, friction fits have a tendency to wear and loosen over time, potentially degrading the connection between incoming and outgoing wires.

It is generally desirable to overcome or ameliorate one or more of the above described difficulties, or to at least provide a useful alternative.

### SUMMARY OF THE INVENTION

In accordance with one aspect of the invention, there is provided an electrical connector for electrically coupling a plurality of electric contacts of a plug to electrically conductive conductors of an electric data cable, the connector having:
(a) a first part including a socket shaped to at least partially receive the plug;
(b) a second part having a plurality of insulation displacement contact slots;
(c) a plurality of electrically conductive contacts extending between the socket and respective ones of said slots; and
(b) a bayonet connection for securing the connector at a connection site.

Preferably, the first and second parts are slidably interlocking.

Preferably, the first part includes an aperture in a side wall of the socket through which end sections of the contacts are adapted to pass on route to predetermined positions within the socket as the first part is slidably interlocked to the second part.

Preferably, during assembly, the contacts are first seated in respective ones of the slots of the second part and then the first part is slidably interlocked with the second part so that said end sections of the contacts pass through the aperture and are located in said predetermined positions within the socket.

Preferably, the connector is an RJ45 connector.

In another aspect, there is provided an RJ45 jack including a bayonet connection for securing the jack at a connection site.

### BRIEF DESCRIPTION OF THE DRAWINGS

The invention is described, by way of non-limiting example only, with reference to the accompanying drawings, in which:

FIG. 1 is a front perspective view of a jack;

FIG. 2 is a rear perspective view of the jack of FIG. 1;

FIG. 3 is a front view of the jack of FIG. 1;

FIG. 4 is a perspective view of contacts of the jack of FIG. 1;

FIG. 5 is a front view of the back part of the jack of FIG. 1;

FIG. 6 is a top view of the front part of the jack of FIG. 1;

FIG. 7 is a side view of the jack of FIG. 1 arranged in a condition of use;

FIG. 8 is a side view of the jack of FIG. 1 arranged in another condition of use;

FIG. 9a is a perspective view of the jack of FIG. 1 and a face panel arranged in a condition of use;

FIG. 9b is a perspective view of the jack and face panel of FIG. 9a arranged in another condition of use;

FIG. 9c is a perspective view of the jack and face panel of FIG. 9a arranged in yet another condition of use; and

FIG. 10 is a back view of a plurality of jacks coupled to a face panel.

### DETAILED DESCRIPTION OF PREFERRED EMBODIMENTS OF THE INVENTION

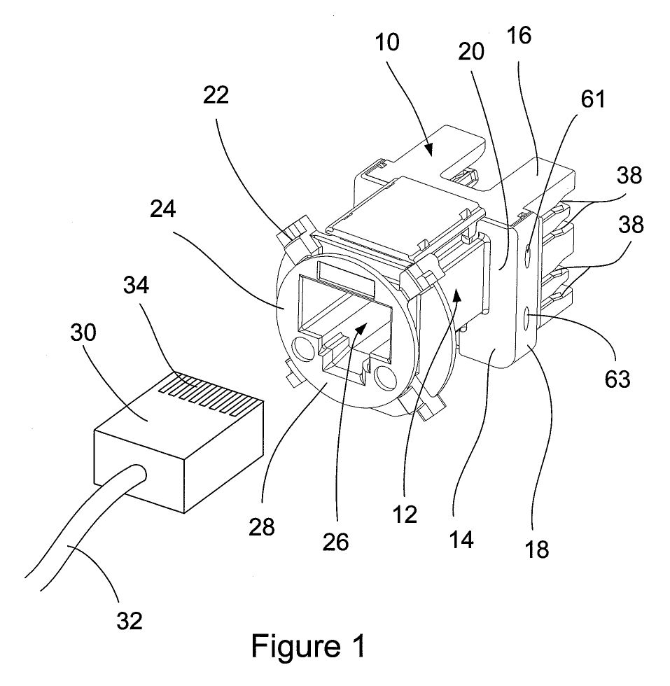

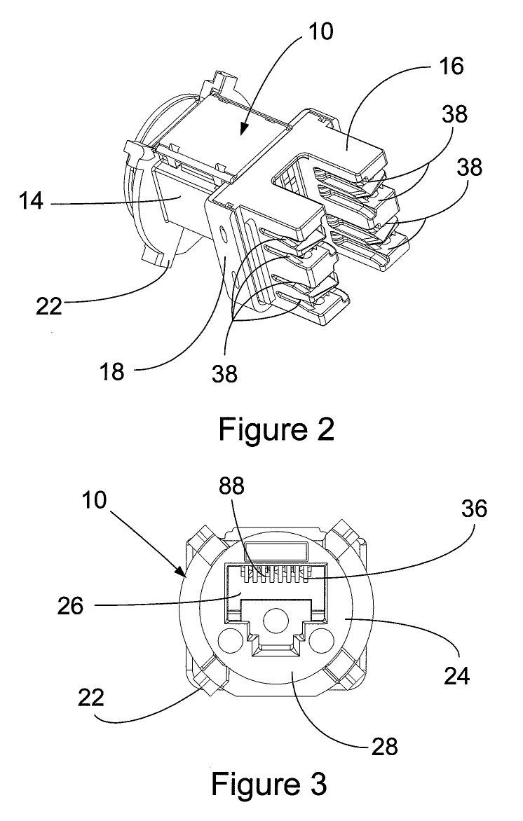

The electrical connector 10, also referred to as the Jack 10, shown in FIGS. 1 to 3 includes a housing 12 formed in front 14 and back 16 interlocking parts. The front part 14 includes a docking section 18 at one end 20 and a bayonet connection 22 at another other end 24. The front part 14 of the housing 12 itself defines an internal socket 26 which opens centrally on a face plate 28 arranged concentrically within the bayonet connection 22. The socket 26 is arranged to receive a plug 30 of an electric communications data cable 32 so that electrically conductive contacts 34 of the plug 30 can mate with corresponding electrically conductive contacts elements 36 of the jack 10. The socket 26 and the plug 30 are preferably RJ-45 type connectors. The back part 16 of the housing 12 includes insulation displacement contact slots 38 that are each shaped to receive an end section of an insulated conductor of another electronic data cable (not shown).

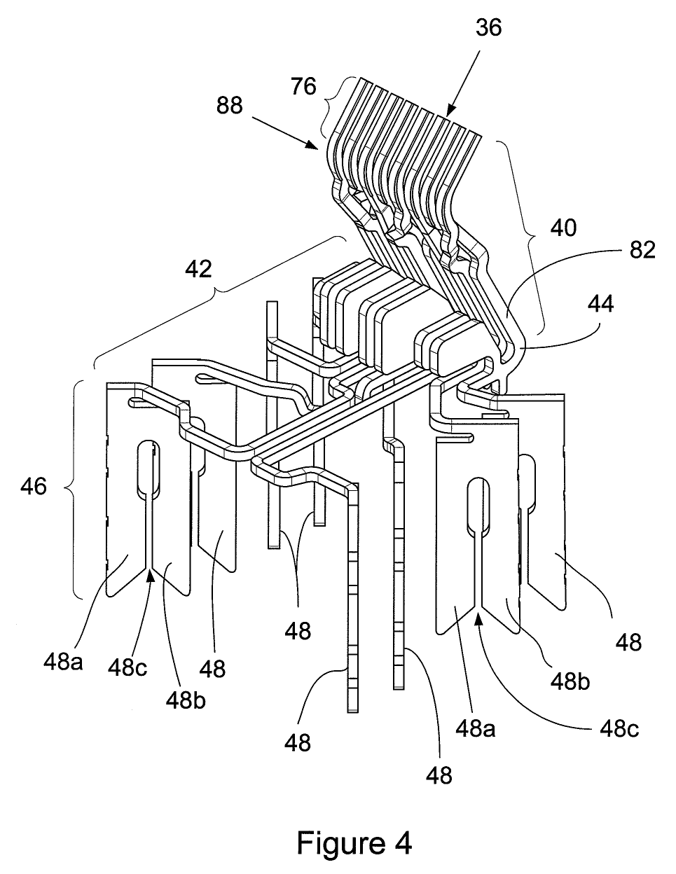

The electrically conductive contact elements 36 each extend between the socket 26 of the front part 14 of the housing 12 and corresponding insulation displacement contact slots 38 of the back part 16 of the housing 12. As particularly shown in FIG. 4, a first end 40 of each contact 36 is a resiliently compressible spring finger contact 40 joined to a fixed planar section 42 by an elbow 44. The spring finger contacts 40 are arranged for electrical connection with corresponding contacts 34 of the mating modular plug 30 when seated in the socket 26. The spring finger contacts 40 resiliently bear against corresponding contact elements 34 of a modular plug when the plug 30 is inserted into the socket 26. Second ends 46 of the contact elements 36 include insulation displacement contacts 48 that open into respective ones of the insulation displacement contact slots 38. Each insulation displacement contact 48 is bifurcated so as to define two opposed contact portions 48a, 48b separated by a slot 48c. The two opposed contact portions 48a, 48b of each insulation displacement contact 48 are laid open in corresponding insulation displacement contact slots 38. As such, an end portion of an insulated conductor can be electrically connected to an insulation displacement contact 48 by pressing the end portion of the conductor into an insulation displacement contact slot 38. In doing so, the contact portions 48a, 48b resiliently engage, and make electrical connection with, the conductor.

The contact elements 36 electrically connect conductors of the plug 30 seated in the socket 26 to corresponding conductors of another electronic data cable coupled to respective ones of the insulation displacement contacts 48 seated in slots 38. The jack 10 can thereby be used to electrically connect the insulated conductors of an electrical communications data cable 32 with the insulated conductors of a communications network.

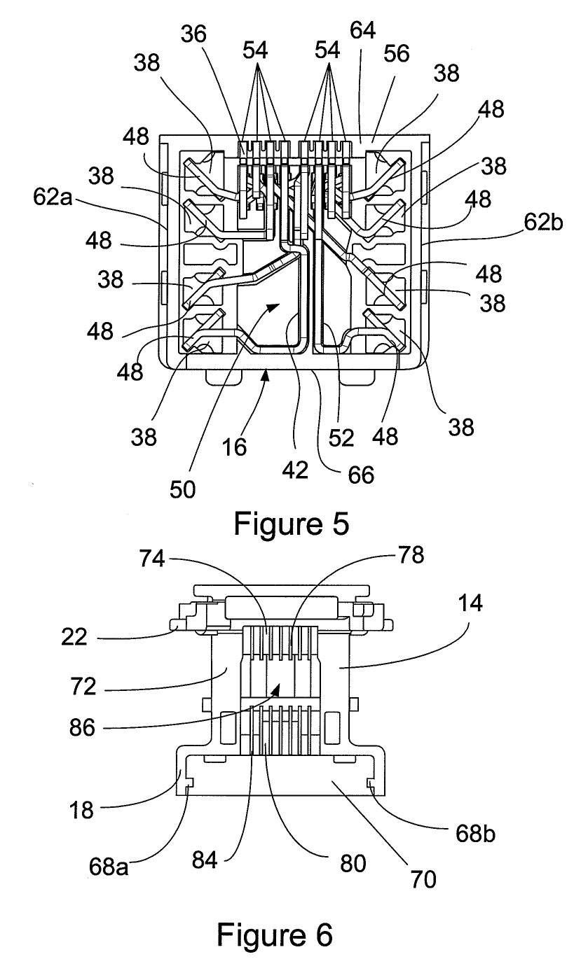

As particularly shown in FIG. 5, a generally planar front side 50 of the back part 16 of the housing 12 includes eight channels 52, each being shaped to receive, and seat therein, a fixed section 42 of a corresponding contact 36. The channels 52 follow predetermined paths designed induce and/or restrict capacitive coupling between adjacent pairs of contacts 36. A description of the arrangement of the channels 32 is set out in further detail below. The channels 52 are predominantly 0.5 mm in depth (depth being defined as the distance recessed in a direction perpendicular to the normal of the plane). However, at any point where two tracks cross one another, the depth of the channel is increased to 1.5 mm. The width of channels 52 is 0.6 mm. The corresponding fixed sections 42 of the contacts 36 are 0.5 mm wide and 0.5 mm deep. The fixed sections 42 of the contacts 36 thereby snugly fit into their corresponding channels 52. Frictional engagement between the channels 52 and the contacts 36 inhibits lateral movement of the contacts 36.

During assembly of the connector 10, the contacts 36 are seated in their respective channels 52 so that the insulation displacement contacts 48 are seated in their insulation displacement contact slots 38. When so arranged, the elbows 44 of each contact 36 are located in seats 54 arranged side by side along a common edge 56 of the top side 50 of the back part 16 of the housing 12. The spring finger contacts 40 extend outwardly away from the front side 50 of the back part 16 of the housing 12 at an angle of sixty degrees, for example, to the planar front side 50 in the manner shown in FIG. 6.

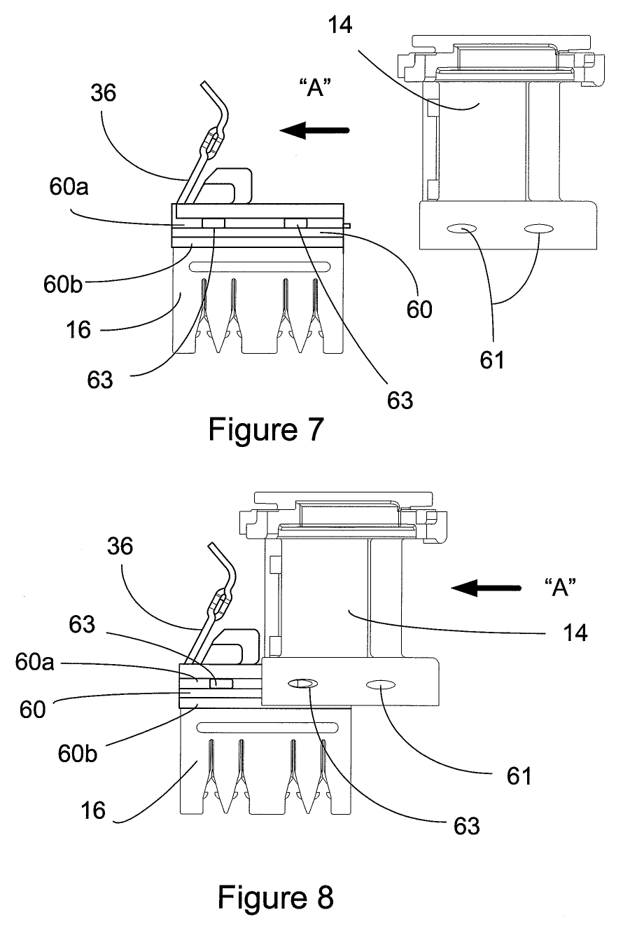

The front part 14 of the housing 12 is slidably couplable to the back part 16, in the manner shown in FIGS. 7 and 8, to encase the contacts 36 therebetween. The left and right sides 62a, 62b of the back part 16 of the housing each include a groove 60 defined by spaced apart ribs 60a, 60b. The grooves 60 run between the top 64 and bottom 66 sides of the housing 12. As particularly shown in FIG. 6, the front part 14 of the housing 12 includes left and right side flanges 68a, 68b that are shaped to pass over respective ones of the grooves 60 when the top part 14 slides over the bottom part 16. A bottom side flange 70 of the front part 14 of the housing 12 abuts the bottom side 64 of the bottom part 16 of the housing 12 when the top part 14 is slid into position in the above-described manner. The bottom side flange 70 limits travel of the top part 14 as it slides over the bottom part 16. The back part 16 and the docking section 18 include interfitting notches 61 and grooves 63 which serve to secure the block 11 in place.

As particularly shown in FIG. 6, the top side 72 of the top part 14 of the housing 12 includes eight parallel terminal channels 74, each being shaped to receive a tip end section 76 of a spring finger contact 40. The terminal channels 74 are defined by seven partitions 78 that extend in parallel outwardly from the top part 14 of the housing 12. The terminal channels 74 locate the tip ends 76 of the contacts 22 in fixed positions so that side to side movement of the spring finger contacts 40 is inhibited and the contacts 36 electrically isolated from each other.

The top side 72 of the top part 14 of the housing 12 also includes eight parallel elbow channels 80, each being shaped to receive a section 82 of the spring finger contacts 40 proximal to the fixed sections 42. The elbow channels 80 are defined by seven partitions 84 that extend in parallel outwardly from the top part 14 of the housing 12. The elbow channels 80 locate the sections 82 of the contacts 40 in fixed positions so that side to side movement of the spring finger contacts 40 is inhibited and the contacts 40 are electrically isolated from each other.

The top side 72 of the front part 14 of the housing 12 includes an aperture 86 defined by the housing 12 and extending between the terminal channels 74 and the elbow channels 80. The aperture 86 extends through a top section of the socket 26 such that contact sections 88 of the contacts elements 36 extending through the aperture 86, between the terminal channels 74 and the elbow channels 80, are accessible from the socket 26. The mating modular plug 30 can thereby be inserted into the socket 26 and effect electrical connection to the contact sections 88 of the contact elements 36.

The spring finger contacts 40 are seated in their respective channels 74, 80 when the front part 14 of the housing slides over the back part 16 of the housing 12 in direction “A” in the manner shown in FIGS. 7 and 8. The contacts sections 88 are seated in the socket 26 when the parts 14, 16 are coupled together in the described manner. Having the front part 14 and the back part 16 of the housing 12 fit together in this manner simulates an over moulding process whereby the fixed sections of the contacts are restrained from four degrees of movement. Don't need to have the costly over moulding process if manufactured in this manner.

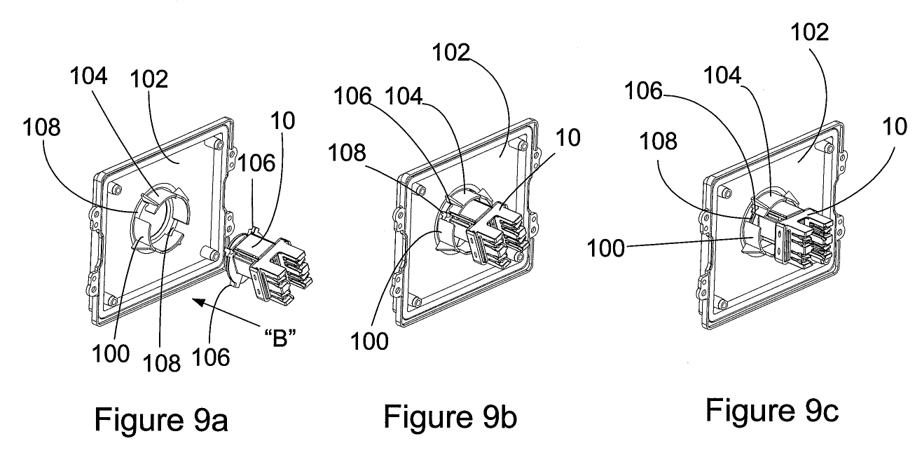

With regard to FIGS. 9a to 9c, the manner of securing the jack 10 at a connection site 100, such as a panel 102. In FIG. 9a, the jack 10 is shown being moved toward a socket 104 in a direction indicated by arrow “B” and in FIG. 9b, radically projecting arms 106 of the bayonet connections 22 are shown received in entry grooves 108 of the socket 104. In order to reliably locate the jack 10, in place, the jack 10 is then simply rotated in a clockwise direction, as shown, in order for the arms 106 to snap fit into lateral slots 108 of the socket 104.

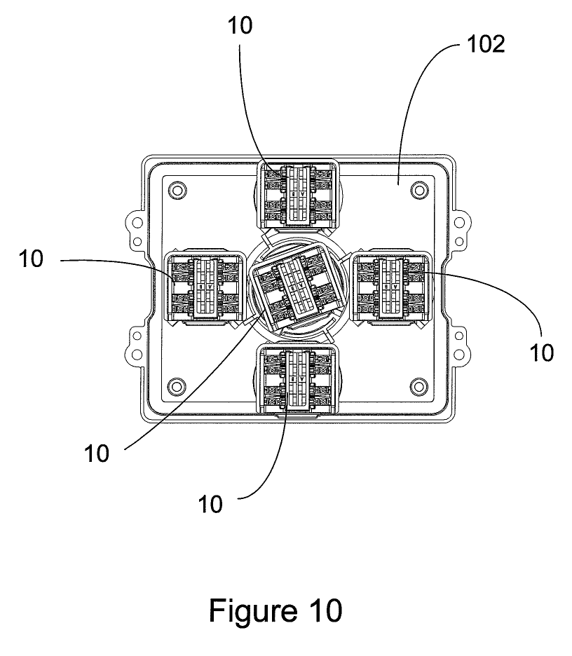

The ease of connection and minimal rotational movement required to reliably secure the jack 10 in place allows for increased density of jacks 10 to be carried by any one panel 102. An example of a five jack 10 configuration, fitted to a single panel 102 is illustrated in FIG. 10.

The bayonet type connection effected between the panel 102 and the jack 10 advantageously provides improved lateral stability when compared with when they are snapped into, screwed in, or friction fitted into, a socket of a mounting frame. The bayonet connection provides a mechanism by which the jack 10 can be coupled and decoupled to/from the plate 102 without effecting the integrity of the connection therebetween.

1. An electrical connector for electrically coupling a plurality of electric contacts of a plug to electrically conductive conductors of an electric data cable, the connector having:
(a) a first part including a socket shaped to at least partially receive the plug;
(b) a second part having a plurality of insulation displacement contact slots;
(c) a plurality of electrically conductive contacts extending between the socket and respective ones of said slots; and
(b) a bayonet connection for securing the connector at a connection site.

2. The connector claimed in claim 1, wherein the first and second parts are slidably interlocking.

3. The connector claimed in claim 2, wherein the first part includes an aperture in a side wall of the socket through which end sections of the contacts are adapted to pass on route to predetermined positions within the socket as the first part is slidably interlocked to the second part.

4. The connector claimed in claim 3, wherein during assembly, the contacts are first seated in respective ones of said slots of the second part and the first part is then slidably interlocked with the second part so that said end sections of the contacts pass through the aperture and are located in said predetermined positions within the socket.

5. The connector claimed in claim 3, wherein the first part includes a docking section for slidably interconnecting with the second part.

6. The connector claimed in claim 5, wherein the docking section has an entry side arranged to receive a base of the second part and guide structure for slidably guiding the base into an engaged condition on the docking section.

7. The connector claimed in claim 6, wherein the guiding structure has guide rails which are received in elongate grooves provided in the base of the second part.

8. The connector claimed in claim 6, wherein the first part has a ramp which extends from the entry side of the docking section into the aperture, the ramp having channels for guiding the contacts, which project from the block, into said predetermined positions in the socket.

9. The connector claimed in claim 8, including a removable cover which is fitted to extend over the ramp and aperture to inhibit ingress of dust into the socket through the aperture.

10. The connector claimed in claim 1, wherein the connector is an RJ45 connector.

11. An RJ45 jack including a bayonet connection for securing the jack at a connection site.
